(19) United States
(12) Patent Application Publication
(10) Pub. No.: US 2025/0098846 A1
(43) Pub. Date: Mar. 27, 2025

(54) Brush Cleaning Apparatus

(71) Applicant: Charles Cooner, Janesville, WI (US)

(72) Inventor: Charles Cooner, Janesville, WI (US)

(21) Appl. No.: 18/889,089

(22) Filed: Sep. 18, 2024

Related U.S. Application Data
(60) Provisional application No. 63/539,800, filed on Sep. 21, 2023.

(51) Int. Cl. A46B 17/06; A46B 9/02; A46B 13/00; A46B 13/04; B44D 3/00

(52) U.S. Cl. CPC A46B 17/06; A46B 9/026; A46B 13/001; A46B 13/04; B44D 3/006; A46B 2200/3073

(57) ABSTRACT

A paint brush cleaning apparatus comprising one or more brush wheels that are rotated into the bristles of a paint brush in the presence of a cleaning solution or liquid to remove paint or other foreign material from the paint brush while urging the cleaning solution or liquid and/or foreign material to be retained in the paint brush cleaning apparatus housing.

### CROSS REFERENCE TO RELATE APPLICATIONS

This application claims the benefit of U.S. Provisional Patent Application No. 63/539,800, filed Sep. 21, 2023, entitled “Paint Brush Washer,” the entire content of which is hereby incorporated by reference.

### FIELD

The present inventions relate to the field of painting and cleaning painting implements. The present inventions more specifically relate to the field of devices for cleaning a paint brush.

### BACKGROUND

Paint brushes come in a variety of sizes, handle types, and bristle composition. Natural-bristle brushes are made with animal hair and apply oil-based paints, varnishes, shellac, and polyurethanes. Natural brush hairs split (flag) to hold more paint and help assure a smooth finish. Synthetic brushes are made of polyester, foam, or nylon. Synthetic brushes work best with all types of latex paints. Brushes can come in a variety of forms including sash, wall, varnish, chip, etc.

When properly used and maintained a paint brush can continue to provide good results and be used several times. Proper maintenance typically involves cleaning the brush's bristles during and/or after use as a brush's results can be hindered or unsatisfactory if the paint or other finish is allowed to remain in the bristles.

Paint brush bristles are typically cleaned by hand using a solution containing water and/or a solvent appropriate for the finish used. Often, the brush is cleaned by running water over the bristles and manually combing or brushing the bristles with a brush comb or steel or nylon brush.

Unfortunately, it is not always convenient to clean the brush during or immediately following use. In addition, cleaning the bristles is time consuming and reduces productivity. In addition, cleaning the bristles can be messy.

Accordingly, there is a need for an apparatus that may be utilized to quickly and easily clean paint brush bristles immediately after use.

Accordingly, there is also a need for a brush cleaner that reduces splashing of water and/or solvent and reduces exposure time to solvent vapors.

### SUMMARY

Accordingly, it is an object of the present disclosure to provide an apparatus that may be utilized to quickly and easily clean paint brush bristles immediately after use.

Accordingly, it is also an object of the present disclosure to provide a brush cleaner apparatus that reduces splashing of water and/or solvent and reduces exposure time to solvent vapors.

Accordingly, it is also an object of the present disclosure to provide a brush cleaning apparatus comprising one or more counter rotatable brush wheels provided in a central space of a housing, each brush wheel having a spindle coupled to a sidewall of a housing and bristles coupled to the spindle; a liquid or solution source positioned and/or oriented to direct a liquid or solution toward the counter rotatable brush wheels; and an opening defined in the housing in communication with the central space of the housing.

Accordingly, it is also an object of the present disclosure to provide a brush cleaning apparatus comprising: counter rotatable brush wheels provided in a central space of a housing, each brush wheel having a spindle coupled to a sidewall of a housing and bristles coupled to the spindle; a liquid or solution source positioned and/or oriented to direct a liquid or solution toward the counter rotatable brush wheels; and an opening defined in the housing in communication with the central space of the housing.

Accordingly, it is also an object of the present disclosure to provide a method of cleaning a paint brush, the method comprising: providing at least a portion of a paint brush through an opening of a housing and into a central space defined by the housing and into contact with one or more multiple rotatable brush wheels provided in the central space; directing a liquid or solution toward at least one of the rotating brush wheels; and rotating the one or more rotatable brush wheels to clean and/or remove foreign material from the paint brush.

Accordingly, it is also an object of the present disclosure to provide a method of cleaning a paint brush, the method comprising: providing at least a portion of a paint brush through an opening of a housing and into a central space defined by the housing between multiple rotatable brush wheels provided in the central space; directing a liquid or solution toward at least one of the rotating brush wheels; and counter-rotating the rotatable brush wheels to clean and/or remove foreign material from the paint brush.

### BRIEF DESCRIPTION OF DRAWINGS

Various examples of embodiments of the systems, devices, and methods according to this invention will be described in detail, with reference to the following figures, wherein:

FIG. 1 illustrates a cross-sectional view of a brush cleaner, according to various examples of embodiments;

FIG. 2 illustrates a cross-sectional view of two brushes of a brush cleaner, according to various examples of embodiments;

FIG. 3 illustrates a perspective view of two brush wheels of a brush cleaner,

according to various examples of embodiments;

FIG. 4 illustrates a side perspective view of a paint brush and two brush wheels and two spray nozzles of a brush cleaner each spraying a liquid, according to various examples of embodiments; and

FIG. 5 illustrates a side perspective view of a paint brush interacting with two brush wheels and liquid from two spray nozzles of a brush cleaner, according to various examples of embodiments.

It should be understood that the drawings are not necessarily to scale. In certain instances, details that are not necessary to the understanding of the invention or render other details difficult to perceive may have been omitted. It should be understood, of course, that the invention is not necessarily limited to the particular embodiments illustrated herein.

### DETAILED DESCRIPTION

Referring to the Figures, a brush cleaner apparatus and method for using same are provided.

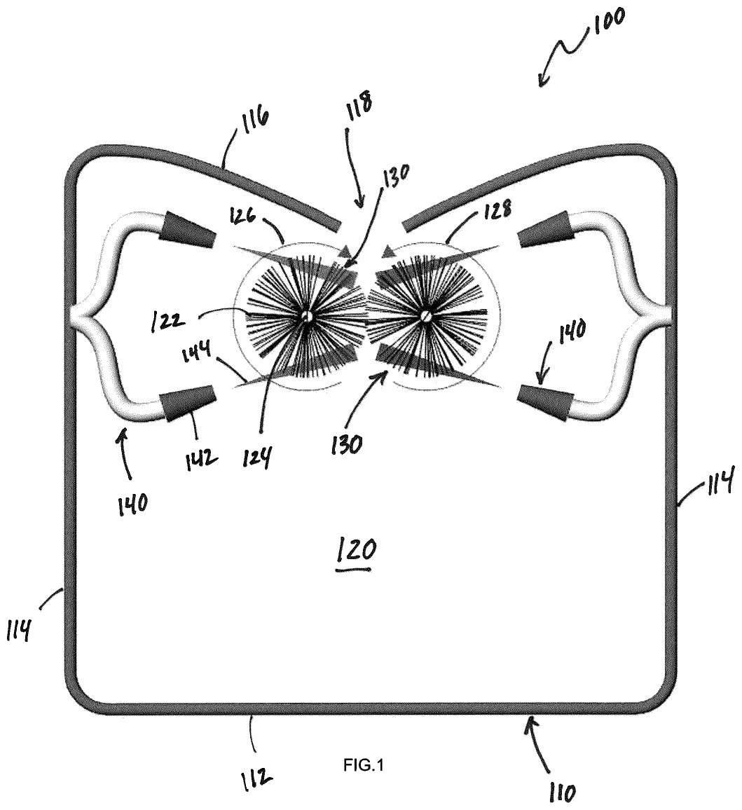

Referring to FIG. 1, a brush cleaning apparatus 100, according to various examples of embodiments, is illustrated. Brush cleaning apparatus 100 includes a housing 110 defining a central space 120, at least one brush or brush wheel 130, and at least one liquid or solution source 140. In various embodiments, brush cleaning apparatus 100 includes dual or multiple brushes 130. In various embodiments, brush cleaning apparatus 100 includes one or more liquid or solution sources 140.

In various embodiments, housing 110 includes a bottom 112, at least one sidewall 114 and a top 116. In various embodiments, bottom 112, one or more sidewalls 114 and top 116 define central space 120. In various embodiments, top 116 defines an opening 118. In various embodiments, opening 118 communicates with central space 120. In various embodiments, at least a portion of top 116 is sloped or curved toward opening 118. Bottom may define or include a drain. Housing may be made of plastic, metal, other materials or combinations thereof.

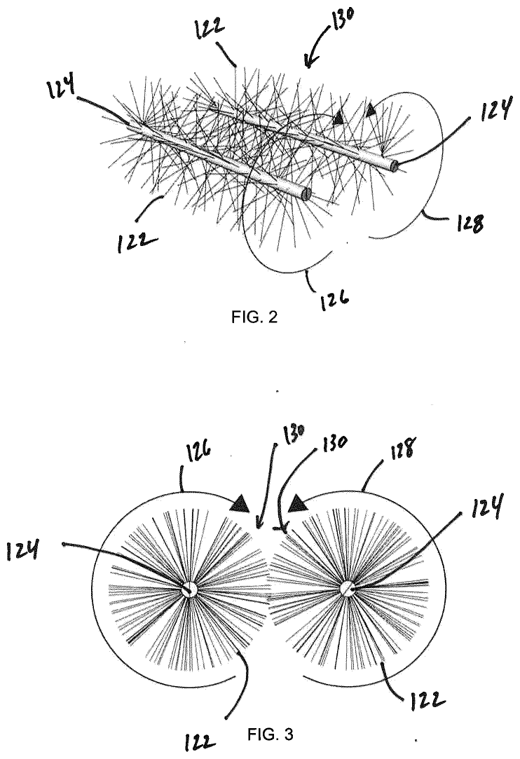

Referring now to FIGS. 1-3, in various embodiments, one or more brush wheels 130 are roller brushes, radial brushes, and/or drum brushes. In various embodiments, brush wheels 130 are provided within housing 110 and/or central space 120. In various examples of embodiments, one of more brush wheels 130 are rotatable. In various embodiments, brush wheels 130 include grit or bristles 122 coupled to a spindle 124 that is rotatably coupled to one or more sidewalls 114 of housing 110. Bristles of grit 122 may be of any grit number or type. The spindles 124 may be manually rotatable or rotatable by one or more electric motors coupled thereto. The spindles may rotate independently or may be rotatable together using gears coupled thereto.

While two brushes or brush wheels are illustrated in the figures, in various embodiments, the brush cleaning apparatus may include only one brush or brush wheel. In various embodiments, apparatus 100 includes multiple brush wheels 130 with bristles that counter turn or rotate or are counter turnable or rotatable (e.g., turn, rotate or are turnable or rotatable in opposite directions). For example, one or more brush wheels 130 may rotate or are rotatable in a clockwise direction, and one or more brush wheels 130 may rotate or are rotable in a counter clockwise direction.

Arrows 126 and 128 illustrate an example counterrotation of two or dual brush wheels 130 according to various examples of embodiments. As illustrated by arrows 126 and 128, brush wheels 130 may be counterrotated such that bristles 122 of each brush wheel 130 near opening move away from opening 118 of housing 110.

In various embodiments, apparatus 100 includes two brush wheels 130, each brush wheel 130 having bristles 122 with or covering a rotational path that overlaps that of the other.

The bristles may be made of plastic, metal, wire, nylon, horsehair, or other materials or combinations thereof.

The one or more liquid or solution sources 140 may take a variety of forms. Referring again to, and as illustrated in FIG. 1, for example, liquid or solution source 140 includes at least one jet, nozzle or sprayer 142. In various embodiments, brush cleaning apparatus 100 includes a jet, nozzle or sprayer 142 provided in central space 120 and oriented and/or positioned to direct a liquid or solution 144 toward bristles 122 of at least one brush wheel 130. In various embodiments, brush cleaning apparatus 100 includes multiple jets, nozzles or sprayers 142 provided in central space 120 and oriented and/or positioned to direct liquid or solution 144 toward bristles 122 of at least one brush wheel 130.

In various embodiments, brush cleaning apparatus 100 includes a jet, nozzle or sprayer 142 provided in central space 120 and oriented and/or positioned to direct a liquid or solution toward bristles 122 of one or more brush wheels 130. In various embodiments, brush cleaning apparatus 100 includes multiple jets, nozzles or sprayers 142 provided in central space 120 and oriented and/or positioned to direct liquid or solution 1444 toward bristles 122 of one or more brush wheels 130.

In various embodiments, each liquid or solution source 140 is fluidly coupled to a liquid or solution supply (e.g., a pressurized liquid or solution supply). Liquid or solution 144 may be water, soap, vinegar, thinner, mineral spirits, or other solution or mixtures of solutions appropriate for the brushes to be cleaned by the brush cleaning apparatus.

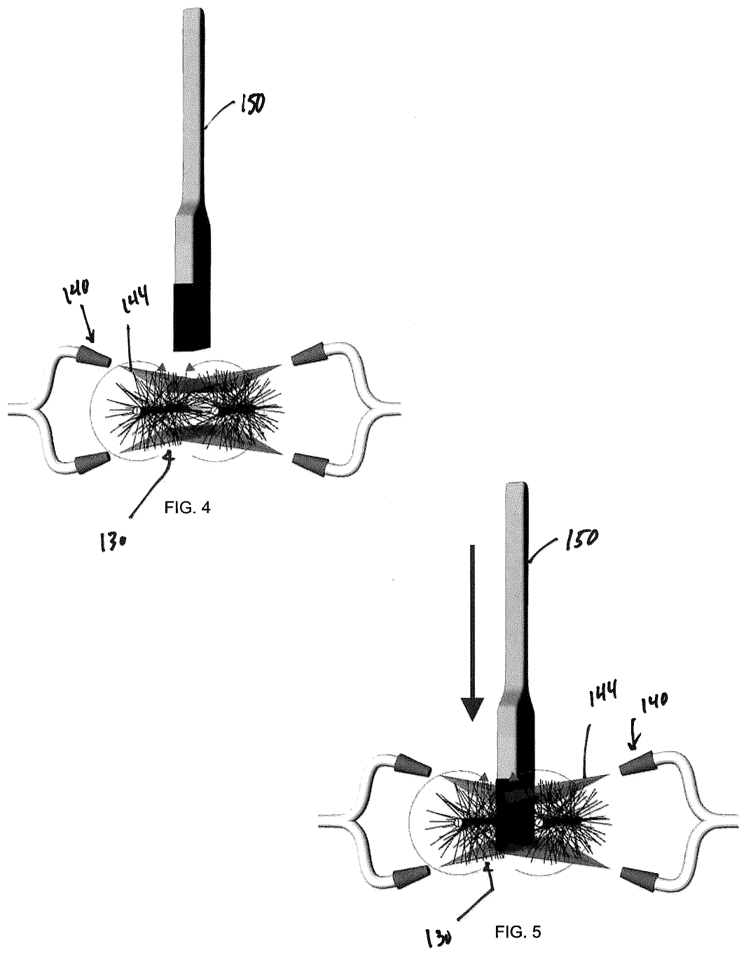

In operation, and referring now to FIGS. 4-5, a paint brush or other brush 150 is provided through opening in housing and into central space. The paint brush may be any type of brush including sash, wall, varnish, chip, etc. A handle of paint brush 150 may remain outside the central space. If the one or more brush wheels 130 are not rotating, or the liquid or solution source 140 is or has not provided liquid or solution 144 into the central space when paint brush 150 is provided into the central space, the brush wheels 130 are rotated (e.g., counter rotated relative to each other) and liquid or solution 144 is provided by liquid or solution source 140 toward brush wheels 130 or otherwise into the central space. In various embodiments, one or more brush wheels 130 helps strip or otherwise remove or loosen foreign material (e.g., paint or varnish) from paint brush 150 (e.g., the bristles of paint brush 150), and the liquid or solution 144 helps draw the foreign material away from paint brush 150 and/or the rotating brushes.

In various embodiments, dual brush wheels 130 are rotated counter to each other to urge or draw solution, liquid, and/or paint or other material away from paint brush 150 and/or the opening. As desired, paint brush 150 may be removed from and/or reinserted into the central space and/or between dual brush wheels 130 as needed or desired until user is satisfied with amount or paint or other foreign material removed or loosened from paint brush 150. Once the user is satisfied with the amount of paint and/or other material removed or loosened from paint brush 150, the brush may be taken from the brush cleaning apparatus, the bristles smoothed, if desired, and the brush left to dry and/or stored.

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

It should be noted that references to relative positions (e.g., “top” and “bottom”) in this description are merely used to identify various elements as are oriented in the Figures. It should be recognized that the orientation of particular components may vary greatly depending on the application in which they are used.

For the purpose of this disclosure, the term “coupled” means the joining of two members directly or indirectly to one another. Such joining may be stationary in nature or moveable in nature. Such joining may be achieved with the two members or the two members and any additional intermediate members being integrally formed as a single unitary body with one another or with the two members or the two members and any additional intermediate members being attached to one another. Such joining may be permanent in nature or may be removable or releasable in nature.

It is also important to note that the construction and arrangement of the system, methods, and devices as shown in the various examples of embodiments is illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements show as multiple parts may be integrally formed, the operation of the interfaces may be reversed or otherwise varied, the length or width of the structures and/or members or connector or other elements of the system may be varied, the nature or number of adjustment positions provided between the elements may be varied (e.g. by variations in the number of engagement slots or size of the engagement slots or type of engagement). The order or sequence of any process or method steps may be varied or re-sequenced according to alternative embodiments. Other substitutions, modifications, changes and omissions may be made in the design, operating conditions and arrangement of the various examples of embodiments without departing from the spirit or scope of the present inventions.

While this invention has been described in conjunction with the examples of embodiments outlined above, various alternatives, modifications, variations, improvements and/or substantial equivalents, whether known or that are or may be presently foreseen, may become apparent to those having at least ordinary skill in the art. Accordingly, the examples of embodiments of the invention, as set forth above, are intended to be illustrative, not limiting. Various changes may be made without departing from the spirit or scope of the invention. Therefore, the invention is intended to embrace all known or earlier developed alternatives, modifications, variations, improvements and/or substantial equivalents.

What is claimed is:

1. A brush cleaning apparatus comprising:
a first rotatable brush wheel provided in a central space of a housing, the first brush wheel having a spindle coupled to a sidewall of a housing and bristles coupled to the spindle of the first rotatable brush wheel;
a liquid or solution source positioned and/or oriented to direct a liquid or solution toward the first rotatable brush wheel; and
an opening defined in the housing in communication with the central space of the housing.

2. The brush cleaning apparatus of claim 1, further comprising a second rotatable brush wheel provided in the central space of a housing, the second brush wheel having a spindle coupled to a sidewall of the housing and bristles coupled to the spindle of the second brush wheel; and whereby the first and second rotatable brush wheels are counter rotatable.

3. The brush cleaning apparatus of claim 2, whereby the bristles of the first rotatable brush wheel have a rotational path that overlaps a rotational path of the bristles of the second rotatable brush wheel.

4. The brush cleaning apparatus of claim 2, whereby the bristles of the first rotatable brush wheel have a rotational path that does not overlap a rotational path of the bristles of the second rotatable brush wheel.

5. The brush cleaning apparatus of claim 2, whereby the spindle of the first wheel brush and the spindle of the second wheel brush are adapted to counter rotate together.

6. The brush cleaning apparatus of claim 2, whereby the spindle of the first wheel brush and the spindle of the second wheel brush are adapted to counter rotate independently.

7. The brush cleaning apparatus of claim 1, whereby the central space is adapted to receive a paint brush.

8. A method of cleaning a paint brush, the method comprising:
providing at least a portion of a paint brush through an opening of a housing and into a central space defined by the housing between multiple rotatable brush wheels provided in the central space;
directing a liquid or solution toward at least one of the rotating brush wheels; and
counter-rotating the rotatable brush wheels to clean and/or remove foreign material from the paint brush.

9. The method of cleaning a paint brush of claim 7, whereby the rotatable brush wheels are counter-rotated in overlapping rotational paths.

10. The brush cleaning apparatus of claim 7, whereby the rotatable brush wheels are counter-rotated in separate rotational paths.

11. The brush cleaning apparatus of claim 7, whereby the rotatable brush wheels are counter rotated together.

12. The brush cleaning apparatus of claim 7, whereby the rotatable brush wheels are counter rotated independently.
